(19) United States
(12) Patent Application Publication
(10) Pub. No.: US 2009/0270082 A1
(43) Pub. Date: Oct. 29, 2009

(54) Method and Device for Communications While Using a Single Telephone Device

(76) Inventor: Dorron Mottes, Tel-Aviv (IL)

Correspondence Address: MYERS WOLIN, LLC, 100 HEADQUARTERS PLAZA, North Tower, 6th Floor, MORRISTOWN, NJ, 07960-6834, US

(21) Appl. No.: 11/794,622

(22) PCT Filed: Dec. 27, 2005
(86) PCT No.: PCT/IL05/01379

§ 371 Date: Jul. 3, 2007

(30) Foreign Application Priority Data
Jan. 4, 2005 (IL) 166143

(51) Int. Cl. H04M 3/42

(52) U.S. Cl. 455/417; 379/211.01

(57) ABSTRACT

For use in a cellular network, a method and device are provided for establishing communication sessions with a user of a single telephone device, wherein the requests to establish the communication sessions are destined to more than one different communication address. Also, there is provided a method for managing a plurality of requests to establish communication sessions with a user of a single desktop telephone device having a single subscriber address identification defined in the cellular network, and wherein the plurality of requests are received while another communication session is active with that user. Also, there is provided a method for establishing communication sessions with a user of such a single desktop telephone device, wherein at least two of the requests for establishing these communication sessions with the user specify each a different communication address.

### FIELD OF THE INVENTION

The present invention generally relates to the field of communications. More particularly, the invention relates to a novel solution for accessing a communication device.

### BACKGROUND OF THE INVENTION

With the ever increasing demand for communication capabilities, and the frequency at which communications are received by everyone nowadays, various problems arises regarding the handing of the increasing flow of communications. In the attempt to cope with some of these problems, different solutions, making use of various fields of telecommunication technology, have been suggested.

Nowadays, it is not unusual to see a telephone user, and particularly cellular telephone user, who has more than one telephone. Needless to say that using two or more such devices is a rather cumbersome task, but it is still one that is performed by those users who, because of any one of a number of reasons, e.g. having a private telephone and one from work, need to have more than one telephone number, a secretary at the office, etc.

A number of prior art publications tried to provide a solution to the problem of having two or more devices associated with a single user, and to the problem of keeping incoming calls on hold.

EP 993,169 teaches a method for handling an incoming call directed to a target telephone that is currently engaged with a present call. The solution suggested describes issuing a first signal to the target telephone to indicate that there is a call waiting, and to issue a second signal to the waiting caller, informing that the target telephone is engaged.

U.S. Pat. No. 6,111,942 describes a communication transfer apparatus which calls a predetermined transferring destination number when an incoming call is detected on a communication line. The transfer apparatus compares a calling-party number received on an incoming-call received line with the predetermined transferring destination number, and if they do not coincide, the transfer apparatus calls the predetermined transferring destination number. If they coincide, the transferring operation is not carried out. Accordingly, meaningless transmission such as transferring an incoming call received from a calling party who is located in the transferring destination can be obviated.

Each of the references mentioned hereinafter is hereby incorporated by reference as if fully set forth herein.

### SUMMARY OF THE INVENTION

It is therefore an object of the present invention to provide a platform for use in a wireless network which allows managing and buffering a plurality of requests to establish communications calls with a single telephone device.

It is yet another object of the invention to provide such a device that is able to receive calls addressed thereto being engaged in another communication session.

It is still another object of the present invention to provide a single desktop telephone connected to a wireless network via a plurality of communication paths, and a method of managing such desktop telephone.

It is yet another object of the present invention to provide a desktop telephone device and a method operative to receive indications related to the currently waiting requests to establish communication sessions with that device and allow its user to respond to these requests.

It is another object of the present invention to provide novel methods and apparatus that enable users to use a single mobile telephone device and be connected to a plurality of different telephone lines.

Additional objects and advantages of the invention will be set forth in the description which follows, and in part will be obvious from the description, or may be learned by practice of the invention. The objects and advantages of the invention may be realized and obtained by means of the instrumentality and combinations particularly pointed out in the appended claims.

According to a first embodiment of the present invention there is provided a method for establishing communication sessions with a user of a single telephone device, wherein the requests to establish these communication sessions are destined to at least two different communication addresses.

According to a preferred embodiment of the invention, the different communication addresses are selected from a group consisting of: cellular telephone numbers, e-mail addresses, Uniform Resource Identifiers (“URIs”), website addresses and any combination thereof.

In accordance with another embodiment of the invention the single telephone device is a member selected from among a cellular telephone, a desktop telephone and a smart phone.

The term “cellular telephone” as used herein should be understood also to encompass a subscriber address identification, i.e. the physical identification of the mobile device, e.g. a SIM card associated with such a cellular phone, the CDMA telephone itself, and the like.

The term “desktop telephone device” (which is also referred herein as “desktop device” or “desktop cellular device” as the case may be) is used herein to denote a device that is linked to a mobile operator's network via the cellular network or via any other method known in the art per se, such as VoWLAN. The desktop device referred to herein may be considered as one of the types of devices encompassed by the term cellular telephone discussed above, and should be understood also to encompass a subscriber address identification, i.e. the physical identification of the mobile device, e.g. a SIM card associated with such a cellular phone, the CDMA telephone itself, and the like.

By yet another embodiment of the invention, the method comprises the steps of:

establishing a pre-defined list of communication addresses to be associated with the single telephone device;

providing a lead address for the single telephone device; and

for each of the other communication addresses associated with the single telephone device, providing a re-routing scheme to enable handling any request to establish a communication session through any of the addresses comprised in that pre-defined list, through that lead number.

The term “lead number” is used herein to encompass also a default number, e.g. the original number of a cellular device. However, this number may be replaced by setting controlling rule(s) to be implemented by the re-routing entity. For example, it is possible to use a certain lead number during working hours while during after-work hours a different lead number may be used. In such a case, the lead number can also be used as the number to which all charges incurred will be associated, preferably while that number was the lead number.

By a preferred embodiment of the invention, the step of establishing a pre-defined list of communication addresses to be associated with the single telephone device further comprises determining the single subscriber address identification to be the lead number for the single telephone device.

According to a preferred embodiment of the present invention, there is provided for use in a cellular network, a method for managing a plurality of requests to establish communication sessions with a user of a single telephone device (e.g. a desktop telephone device), where this telephone device has preferably a single subscriber address identification defined in said cellular network, e.g. a single SIM card. In the alternative, the single telephone device may be provided with more than one such SIM card. The method allows receiving and processing plurality of requests for establishing communication sessions while another communication session is being held with that user. For example, when the user of a telephone device is busy in a telephone conversation, a number of additional calls may still be managed rather than be discarded once there is already a call waiting addressed to the very same telephone number.

According to an embodiment of the invention the method further comprising the step of providing the user with indications, to enable the user become aware of the requests received for establishing the communication sessions, and particularly those request that are currently pending.

By another embodiment of the invention, the method provided further comprises a step of determining which of the plurality of requests shall be accepted. Preferably, the determination is made by the user of the single telephone in response to receiving the indications of the currently waiting requests.

According to yet another embodiment, the plurality of requests identified for acceptance, are retained in a buffer managed by the cellular network management system.

In accordance with still another embodiment, the order of the requests queued in the buffer can be changed in response to one or more instructions generated by the user (e.g. to advance on the requests so that a voice call be established prior establishing other session(s), even other voice calls, that arrived prior to the arrival of that request, etc.)

By still another embodiment, the method further comprises the step of displaying indications of the address designated in the request received for establishing a communication session to the user of the single telephone device, before actually establishing the requested session. In addition or in the alternative, the indications displayed are of the requests received, and preferably those that are still pending. The user views these requests at the display means (e.g. a telephone display, a computer screen) and may act upon, e.g. by manipulating their order, rejecting some requests, diverting calls to a voice mail box or answering service, view if any of the calls that were pending were disconnected by their initiator, etc.

According to another embodiment, the single telephone device further comprises means to receive and display a message associated with the communication session being established, where such message can be a USSD type of message, or a real time data message transmitted via a data communication channel and the like. Preferably, the message comprises the number called and/or identification of the address of the device initiating the communication session.

According to still another embodiment, the communication session comprises transferring and/or receiving signals that belong to a group that consists of: data signals, video signals, voice signals, facsimile signals or any combination thereof.

Let us consider an example where the single telephone device is a desktop telephone device, and the device is provided with a single physical subscriber address identification defined in a cellular network e.g. a desktop telephone provided with a SIM card (or CDMA telephone device), and adapted to communicate over the wireless network directly or via a VoWLAN, while being managed via the wireless network. The telephone itself may be similar to a PBX smart digital telephone, e.g. so as to include features a desktop user would require, such as extension buttons, transfer and conference buttons, and/or any other programmable buttons.

Thus, according to an embodiment of the present invention there is provided a method for establishing communication sessions with a user of a single desktop telephone device associated with a cellular network following receipt of requests for establishing these communication sessions, and wherein at least two of these requests specify each a different communication addresses, e.g. the other parties initiating the call, specify different destination addresses, such another telephone number, instant messaging address, an e-mail address, etc. that should reach the same desktop telephone device. As previously explained, the single desktop telephone device is provided with a single subscriber address identification defined in a cellular network, e.g. communication address in a cellular network associated with a SIM card. The other address(es), such as other cellular telephone number(s), are preferably virtual cellular communication address(es), but can also be other subscriber address identifications such as additional SIM cards.

According to still another embodiment of the invention, the method further comprising a step of providing the single desktop telephone device with an indication that relates to an address specified in the request to establish a communication, prior to establishing that communication session.

By yet another embodiment of the invention the method further comprising a step of associating at least one message with at least of the requests for establishing the communication sessions and forwarding that message to the single desktop telephone device. Preferably, this message is selected from among: a voice message, a text message, a video message and any combination thereof. Still preferably, the message comprises details associated with an arriving request for establishing the communication session, e.g. where the details are at least one member of the group consisting of: identification of the party requesting the establishing of said communication session (e.g. automatic number identification of the device initiating the communication session), identification of the address for which said request arrived, priority level, and any combination thereof.

In accordance with yet another embodiment of the invention, the method further comprising a step of diverting a call destined to that single telephone device, to an address which is not included in the pre-defined list of communication addresses, e.g. a secretary may divert the call received for the boss, to another device such as a cellular phone, a diversion which may depend upon the boss current location.

In addition, the diversion may be carried in response to determining that the request made for establishing said communication session specifies one or more specific addresses, out of the addresses included in said pre-defined list of communication addresses. Preferably, a message may be associated with the diverted communication session. Still preferably, this message is generated in response to a pre-define code sent by the user of the single desktop telephone device, e.g. considering the example given above, the secretary may divert the call by pressing certain code or a certain key that was configured to be the agreed upon code. Once that happens, a pre-defined message shall be generated thereby providing the boss with certain information relating to the request for communication session that is being established. Similarly, mutates mutandis, the transfer can be requested by the desktop telephone user (e.g. when the user is busy with another communication session) and executed by a switch associated with the network to which that desktop telephone belongs. According to another option or alternative, upon receiving the indication(s) of the requests that are currently pending, the user may decide to divert the call that he/she is currently engaged with by applying any of the methods described above, and accept one of the waiting requests to establish the communication session. By yet another embodiment of the invention, the method provided further comprising a step of providing a pre-defined auto reply to a party requesting to establish a communication session, in response to receiving that request at the single desktop telephone device, e.g. at one specific number of those associated with that single desktop telephone device.

Preferably, the pre-defined auto reply is selected based on the type of the device originating the incoming call, and may be a member selected from the group consisting of: an e-mail, an SMS, a voice message, and the like. Optionally, or in the alternative, the user may make a real time decision, e.g. while the call is ringing or after a message regarding the incoming call waiting is received, on the auto-reply to be used in conjunction with the present call.

According to still another embodiment, the method further comprising a step of forwarding a communication session to an answering service, upon determining that the communication address specified in the request made for establishing said communication session, is, a pre-defined one of the addresses included in the pre-defined list of communication addresses.

According to still another embodiment of the invention, the method provided further comprises the step of receiving a plurality of requests to establish communication sessions with said user of the single desktop telephone device while conducting a real-time type of communication session (such as voice session or a video session), and determining which of the other requests will be accepted.

Preferably, all of the other requests that have been identified for acceptance (independent of their number) are kept in a buffer managed by the cellular network management system, while the non-accepted ones are rejected, preferably with a message played or displayed to the originator of the call.

According to another aspect of the invention, there is provided a desktop telephone device having a single subscriber address identification defined in a cellular network and adapted to receive a plurality of requests to establish communication sessions, while at least one other communication session is being conducted via this desktop telephone device.

According to another embodiment of the invention, there is provided a desktop telephone device having a single subscriber address identification defined in a cellular network and adapted to receive a plurality of requests for establishing communication sessions through a cellular network, wherein at least one of these requests specify a communication address other than that single subscriber address.

Preferably, the desktop telephone further comprises means operative to receive an indication that relates to a communication address specified in a request to establish a communication session, before establishing the requested communication session.

According to a preferred embodiment of this aspect of the invention, the desktop telephone device further comprises means to receive and display a message associated with each of these requests to establish a communication sessions. Such a message may be a USSD type of message, a real time data message sent over a mobile data channel, or an IP channel and the like.

Preferably, the message comprises identification of the address of the called number, e.g. the automatic number identification of the device initiating the communication session.

In accordance with still another embodiment of the invention, the desktop telephone device further comprises display means adapted to display a plurality of requests to establish communication sessions received and are currently kept on hold.

By yet another preferred embodiment, the desktop telephone device further comprises means adapted to indicate which of the requests currently kept on hold, will be accepted (or alternatively, which will be rejected) by the user of said desktop telephone device.

According to still another aspect of the invention, there is provided a cellular network communication platform comprising buffering means adapted to buffer requests to establish a plurality of communication sessions with a single desktop telephone device having one or more subscriber address identification(s) defined in said cellular network, wherein the plurality of requests are buffered while the single desktop telephone device is engaged with another communication session. Preferably, the single desktop telephone device has a single subscriber address identification (e.g. a SIM card) defined in said cellular network, but this embodiment of the invention should be understood to encompass also single desktop telephone device which is provided with two or more such subscriber address identifications, as long as the requests to establish communication sessions through these two or more subscriber address identifications, are managed as if they were destined to a single subscriber, e.g. by establishing a single queue at the cellular network communication platform for all the arriving requests for establishing communication sessions with that single desktop telephone device, irrespective of whether the communication address specified in these requests specifies the address of one SIM card or another.

According to another embodiment of the invention there is provided, a cellular network communication platform adapted to receive requests to establish a plurality of communication sessions that specify at least two different communication addresses, and to route these requests to a single desktop telephone device having a single subscriber address identification defined in a cellular network.

By yet another embodiment, the cellular network platform further comprises means operative to send indications to desktop telephone devices of the present invention, before establishing the communication sessions, and wherein these indications relate to the communication addresses specified in the requests received for establishing these communication sessions.

Preferably, the cellular network communication platform comprises the following:

means for establishing a pre-defined list of communication addresses to be associated with a single said desktop telephone device;

means for providing a lead number for that single desktop telephone device; and

means for carrying out a routing scheme to enable handling a request to establish a communication session through any of the addresses comprised in that pre-defined list, through this lead number.

According to still another embodiment, the cellular network communication platform further comprises means operative to receive a plurality of requests directed to the single desktop telephone device, and forward indications relating to the incoming requests towards that single desktop telephone device. In case a communication session is currently being held by the user of that single desktop telephone device, the platform shall retain some or all of these other requests to establish the communication sessions in a queue managed at the platform, and may be further receive instructions from the desktop telephone on how to handle one, some or all of the queued requests, which will preferably override the managing rules by which the platform would otherwise manage the queue.

The cellular network communication platform according to another embodiment of the present invention, further comprises means operative to receive an indication from the user of the single desktop telephone device to reject one or more of the requests currently held in queue, and in response to receiving that indication, rejecting the corresponding request, preferably while associating a message directed to the originator of the request, e.g. “the number you dialed is currently busy” etc. or send to a Voice Mail (“VM”).

By yet another preferred embodiment, the cellular network communication platform further comprises means operative to associate a message with a communication session being established, for display at the single desktop telephone device. Preferably, the message is selected from among: a voice message, a text message, a video message and any combination thereof. Typically, the message is transmitted by using USSD type of transmission, or by using a real time data message sent over a mobile data channel, or an IP channel or by any other method known in the art per se.

Preferably, the message comprises details associated with the arriving request for establishing the communication session, where these details are preferably at least one member of the group consisting of: identification of the party requesting to establish that communication session, identification of the address specified in the arriving request, priority level, and any combination thereof.

According to still another embodiment of the invention, there is provided a cellular network communication device further comprising means adapted to forward a request for communication session to an answering service in response to determining that the address specified in that request is a specific address included in the pre-defined list of communication addresses.

By yet another embodiment of the invention, the cellular network communication device further comprising means for diverting a request to establish a communication session that specifies at least one specific communication address out of said pre-defined list of communication addresses to a replacement device, in response to receiving a prior request sent by the user of the single desktop telephone device.

According to still another preferred embodiment, the cellular network communication device comprises:

means for establishing a pre-defined list of communication addresses to be associated with the user's mobile device;

means for providing a lead number for the user's mobile device; and

means for carrying out a re-routing scheme to enable handling a request to establish a communication session through any of the addresses comprised in the pre-defined list, through that lead number.

Preferably, the cellular network communication device further comprises a user buffer that is operative to store at least one address associated with that user, means operative to prevent the establishing of communication sessions with the user through using any of the communication addresses associated with the user's mobile device in response to the user's request to prevent incoming communication sessions, and control means operative to determine if a request for communication session arrives to that at least one address, and if in the affirmative, override the means operative to prevent the establishing of the sessions and allow establishing that session.

By yet another embodiment of the invention, the cellular network communication device further comprises means for diverting a communication session destined to the mobile device, to an address which is not included in the pre-defined list of communication addresses associated with that user.

Preferably the cellular network communication device further comprises determination means operative to determine whether the destination of the request made for establishing the communication session is to one or more of the addresses included in said pre-defined list of communication addresses, and control the diversion means accordingly. Still preferably, the cellular network communication device further comprises means for associating a message with the diverted communication session.

In accordance with yet another embodiment of the invention, the cellular network communication device further comprises means for transmitting audio signals and/or video signals while the communication session with the user's mobile device is being established, or while the communication session is being kept on hold. Preferably, the audio signals and/or video signals are selected in response to identifying the type of the device initiating the call. Such audio or video signals may be selected from among a plurality of audio or video clips based on one or more selection criteria of the group consisting of: the address called, caller ANI and time of the day.

The term Automatic Number Identification (ANI) as will be used herein should be understood to encompass all means and methods known in the art for the identification of the caller number, as the case may be, such as ANI, callerID, MSISDN, etc.

The communication session preferably comprises transferring data signals, voice signal, facsimile signals or any combination thereof.

According to a preferred embodiment of the present invention, there is provided for use in a cellular network described above, a method for managing a plurality of requests to establish communication sessions with a user of a single mobile communication device which is provided with more than one communication addresses associated with a private network. Thus according to the method provided by this embodiment of the invention, it is possible to receive and process a plurality of requests while another communication session is being held with the user of the mobile communication device. For example, when the user of the telephone device is busy in a telephone conversation, a number of additional calls may still be managed rather than be discarded once there is already a call waiting addressed to the very same telephone number of the mobile device.

According to an embodiment of the invention the method further comprising the step of providing the user with indications, to enable the user to become aware of the requests received for establishing these communication sessions, and particularly those request that are currently pending.

By another embodiment of the invention, the method provided further comprises a step of determining which of the plurality of requests shall be accepted. Preferably, the determination is made by the user of a mobile device in response to receiving the indications of the currently waiting requests.

According to yet another embodiment, the plurality of requests identified for acceptance, are retained in a buffer managed by the cellular network management system.

In accordance with still another embodiment, the order of the requests queued in the buffer can be changed in response to one or more instructions generated by the user (e.g. to advance on the requests so that a voice call be established prior establishing other session(s), even other voice calls, that arrived prior to the arrival of that request, etc.)

By still another embodiment, the method further comprising the step of displaying to the user at the mobile device, indications of the requests received, and preferably those that are still pending. The user views these requests at the display means (e.g. a telephone display) and may act upon, e.g. by manipulating their order, rejecting some requests, diverting calls to a voice mail box or answering service, view if any of the calls that were pending were disconnected by their initiator, etc.

According to still another embodiment of the invention, the method further comprising a step of providing the single mobile telephone device with an indication that relates to an address specified in the request to establish a communication, prior to establishing that communication session.

Preferably, all of the other requests that have been identified. for acceptance (independent of their number) are kept in a buffer managed by the cellular network management system, while the non-accepted ones are rejected, preferably with a message played or displayed to the originator of the call.

According to another aspect of the invention, there is provided a mobile telephone device having a single 5 subscriber address identification defined in a cellular network and adapted to receive a plurality of requests to establish communication sessions while at least one other communication session is being conducted via this mobile telephone device.

According to another embodiment of the invention, there is provided a mobile telephone device having a single subscriber address identification defined in a cellular network and adapted to receive a plurality of requests for establishing communication sessions through a cellular network, wherein at least one of these requests specify a communication address other than that single subscriber address.

Preferably, the mobile telephone device (e.g. the desktop telephone device) further comprises means operative to receive an indication that relates to a communication address specified in a request to establish a communication session, before establishing the requested communication session.

According to a preferred embodiment of this aspect of the invention, the mobile telephone device (e.g. the desktop telephone device) further comprises means to receive and display a message associated with each of these requests to establish a communication sessions. Such a message may be a USSD type of message, a real time data message sent over a mobile data channel, or an IP channel and the like.

Preferably, the message comprises identification of the address of the called number, e.g. the automatic number identification of the device initiating the communication session.

In accordance with still another embodiment of the invention, the mobile telephone device further comprises display means adapted to display a plurality of requests to establish communication sessions received and are currently kept on hold.

By yet another preferred embodiment, the mobile telephone device further comprises means adapted to indicate which of the requests currently kept on hold, will be accepted (or alternatively, which will be rejected) by the user of said mobile telephone device.

According to still another aspect of the invention, there is provided a cellular network communication platform comprising buffering means adapted to buffer requests to establish a plurality of communication sessions with a single mobile telephone device having one or more subscriber address identification(s) defined in said cellular network, wherein the plurality of requests are buffered while the single mobile telephone device is engaged with another communication session. Preferably, the single mobile telephone device has a single subscriber address identification (e.g. a SIM card) defined in said cellular network, but this embodiment of the invention should be understood to encompass also single mobile telephone device which is provided with two or more such subscriber address identifications, as long as the requests to establish communication sessions through these two or more subscriber address identifications, are managed as if they were destined to a single subscriber, e.g. by establishing a single queue at the cellular network communication platform for all the arriving requests for establishing communication sessions with that single mobile telephone device, irrespective of whether the communication address specified in these requests specifies the address of one SIM card or another.

According to another embodiment of the invention there is provided, a cellular network communication platform adapted to receive requests to establish a plurality of communication sessions that specify at least two different communication addresses, and to route these requests to a single mobile telephone device having a single subscriber address identification defined in a cellular network.

By yet another embodiment, the cellular network platform further comprises means operative to send indications to mobile telephone devices of the present invention, before establishing the communication sessions, and wherein these indications relate to the communication addresses specified in the requests received for establishing these communication sessions.

According to still another embodiment, the cellular network communication platform further comprises means operative to receive a plurality of requests directed to the single mobile telephone device, and forward indications relating to the incoming requests towards that single mobile telephone device. In case a communication session is currently being held by the user of that single mobile telephone device, the platform shall retain some or all of these other requests to establish the communication sessions in a queue managed at the platform, and may be further receive instructions from the mobile telephone on how to handle one, some or all of the queued requests, which will preferably override the managing rules by which the platform would otherwise manage the queue.

The cellular network communication platform according to another embodiment of the present invention, further comprises means operative to receive an indication from the user of the single mobile telephone device to reject one or more of the requests currently held in queue, and in response to receiving that indication, rejecting the corresponding request, preferably while associating a message directed to the originator of the request, e.g. “the number you dialed is currently busy” etc. or send to a Voice Mail (“VM”).

By yet another preferred embodiment, the cellular network communication platform further comprises means operative to associate a message with a communication session being established, for display at the single mobile telephone device. Preferably, the message is selected from among: a voice message, a text message, a video message and any combination thereof. Typically, the message is transmitted by using USSD type of transmission, or by using a real time data message sent over a mobile data channel, or an IP channel or by any other method known in the art per se.

Preferably, the message comprises details associated with the arriving request for establishing the communication session, where these details are preferably at least one member of the group consisting of: identification of the party requesting to establish that communication session, identification of the address specified in the arriving request, priority level, and any combination thereof.

According to still another embodiment, the cellular network communication device further comprises means for diverting a communication session destined to one of the communication addresses associated with the single mobile telephone device, to another address which is not included in the pre-defined list of communication addresses (e.g. a request to establish call arriving to a boss, is diverted to the secretary's boss).

According to still another embodiment of the invention, there is provided a cellular network communication device further comprising means adapted to forward a request for communication session to an answering service in response to determining that the address specified in that request is a specific address included in the pre-defined list of communication addresses.

By yet another embodiment of the invention, the cellular network communication device further comprising means for diverting a request to establish a communication session that specifies at least one specific communication address out of said pre-defined list of communication addresses to a replacement device, in response to receiving a prior request sent by the user of the single mobile telephone device.

### BRIEF DESCRIPTION OF THE DRAWINGS

FIG. 1 is a flow chart illustrating the implementation of a method in accordance with an embodiment of the invention;

FIG. 2 is a flow chart illustrating a somewhat different way of implementing a method in accordance with another embodiment of the invention; and

FIG. 3 is a block diagram illustrating an implementation of a method in accordance with an embodiment of the invention.

### DETAILED DESCRIPTION OF PREFERRED EMBODIMENTS

The present invention will be understood and appreciated more fully from the following detailed description.

Let us consider as an example that all the addresses (telephone numbers) included in the pre-defined list of addresses are cellular telephone numbers and are all handled and managed by a public cellular network. Still, a somewhat similar solution may also apply when one or more of the addresses comprised in that pre-defined list are wireline numbers. In such a case, when a request to establish a communication session with one of the wireline numbers is received at the PSTN, it will automatically be forwarded to the pre-defined cellular number according the applicable re-routing rule, so that the caller who called a wireline. telephone number will have his call first diverted to the cellular network, and then processed in accordance with the description of the invention as disclosed herein.

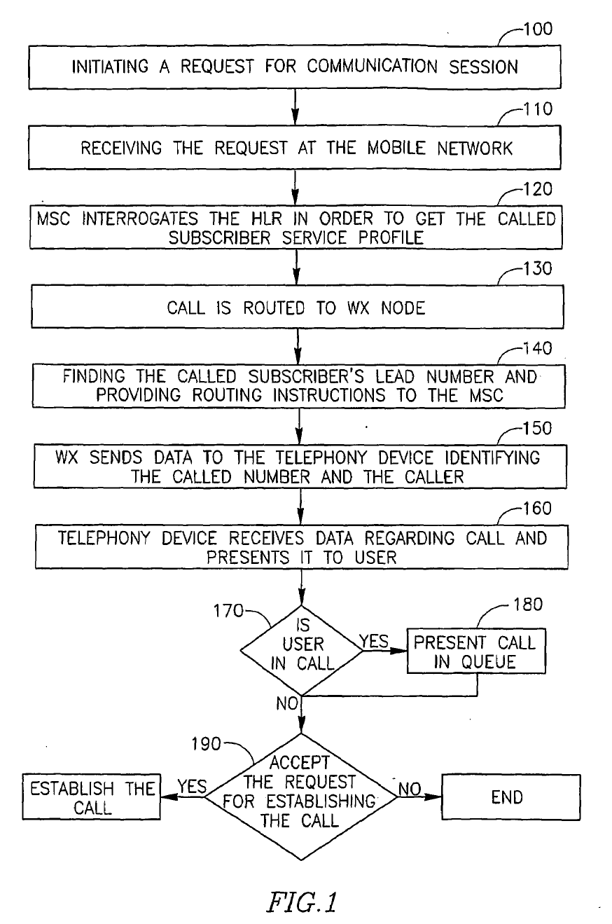

Let us now consider the flow chart shown in FIG. 1, which demonstrates an example of implementing the solution provided by the present invention for voice calls addressed to a single desktop telephone device which is provided with one or more SIM cards and thus, becomes an end device in a cellular communication network, where this desktop telephone has one or more lines (different communications addresses) associated therewith, and all of these lines are managed by the wireless centrex (“WX”) node. In the present example, a wireless Centrex platform is also associated with that cellular network and manages the desktop telephone device of the example.

By this example, a request is initiated to establish a communication session, e.g. a telephone call, with the subscriber using the desktop telephone in the cellular network, as explained above (step 100). The request may either be initiated by a user belonging to that cellular network, or from any external network (i.e. PSTN, another cellular network, etc.). Similarly, the request may be in the form of an e-mail sent to the user's e-mail address, for presenting it on his desktop telephone device.

The request enters the cellular network (step 110) via a Gateway Mobile Switching Center (GMSC), for example: a call from the PSTN with a cellular dialed number will be routed to the GMSC, and received at a MSC/GMSC of the cellular network.

The MSC/GMSC then interrogates the HLR (step 120), in order to get the called subscriber service profile. According to the HLR's Terminate IN Key, the IN signaling of the call is routed toward a wireless centrex node (“WX”) such as the one described in our co-pending application IL 165362 filed on Nov. 24, 2004. Alternatively, the IN signaling of the call will be routed toward the WX according to the dialed number (e.g. all numbers between “1001” and “1100” should be routed to the WX) (step 130).

The WX receives details about the call initiator (i.e. ANI, called number, if the subscriber is attached to the network or the last VLR update), and is able to link the request by the lead (e.g. default) number and the list of additional numbers (addresses) associated at the WX node with that subscriber. When a call is received for any of the subscriber's lines, the following process is initiated.

At the WX, the number dialed is matched against the pre-defined list, and the appropriate lead number for the subscriber is determined, and based on the information available, e.g. the lead number, routing tables, rules and other information, returns to the MSC with routing instructions for that call (step 140). In some cases, in which the mobile network has limited IN capabilities, or additional resources are needed, the WX may request to route the call to the WX Service Node, which will physically control and route the call. WX can request the MSC to place the call in queue or on hold on network, until further instructions are received from WX (while WX receives instructions from user). WX can request to place in queue or on hold more then one call for this default number.

The WX interacts with the desktop telephone device via a mobile data connection (which can alternatively be done via an IP connection), and the interaction can be done by using protocols such as SIP, proprietary or others known in the art per se. The WX sends to the subscriber's desktop telephone information regarding the called number, preferably with information regarding the ANI of the caller (step 150).

The desktop telephone receives the information which is then presented to the user while the telephone is ringing (step 160). If the user is engaged with a current call, he will receive an indication of the new call arriving, and will be able to view the calls which are already in the queue preferably together with their related information. This viewing is done according to this example via the telephone device interface.

If the user is busy in a call (step 170), he may view the call in the queue call screen (step 180) and at any time can select via the desktop telephone device interface any of these queued calls and accept or reject that call (step 190).

In the alternative, the user receives in step 160 the data relating to the incoming call before the telephone is ringing or while ringing. Then the user may select an action from a known list. The desktop telephone device transfers the selection made by the user to WX node, which will route the call based on the user's selection and other parameters stored at the management of the WX.

The MSC will route the call based on the instructions received from the WX, while the latter continues to manage the call and to receive updates regarding the call's status (e.g. once the call is disconnected the MSC will send the information to the WX via signaling). Based on the instructions received from the desktop telephone user and/or the call information and/or the WX routing tables and rules and other parameters, the WX decides if and when to make changes in respect of this call.

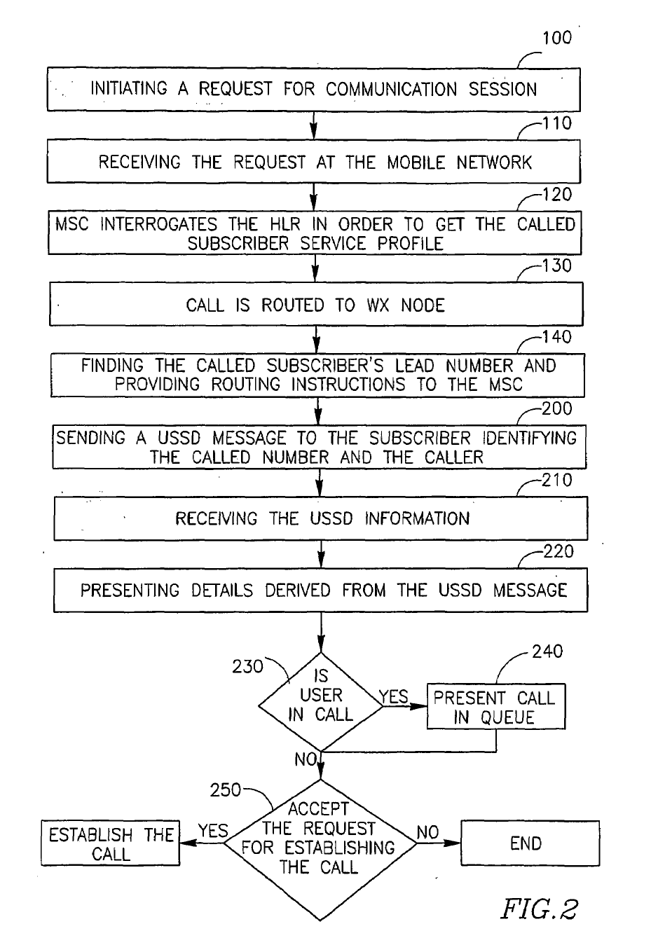

By another alternative embodiment of the invention described in FIG. 2, a USSD message is sent to the subscriber's lead number defined for his desktop telephone device, preferably with information regarding the called number and ANI of the caller (step 200), after carrying out steps 100 to 140, described above.

The user's desktop telephone device receives the information embedded in the USSD message while his telephone is ringing (step 210).

The desktop telephone device presents details derived from the USSD (step 220).

The Subscriber views the incoming call screen, and can accept or reject the call (step 230). In a way similar to that described above, if the user is busy with another call, he may view the in queue call screen (step 240) and at any time accept or reject a call of those in queue (step 250).

Let us consider now the case where a number of requests to establish communication sessions with the user of the desktop telephone have arrived (through any one of the numbers associated with that desktop telephone as the corresponding communication addresses of that telephone. Let us also assume that these requests arrived while the user has been engaged in another communication session, e.g. a telephone conversation. Now the requests are queued in the cellular system, preferably in a buffer of the wireless centrex associated with the cellular network, and these requests are forwarded to the desktop telephone. Upon viewing the waiting requests the user may, while still conducting the communication session he is engaged with, select which of the other requests shall be accepted, and when the WX receives the user selection, it will act upon by retaining all of these requests identified for acceptance, in a buffer managed by the cellular network management system, and rejecting the others (e.g. responding to the requests with a pre recorded voice message).

Furthermore, the user may view at the desktop display the current order by which the requests were queued in the buffer, and change this order of the requests queued in the buffer, by providing one or more appropriate instructions to the WX. This way, the user may select say call number 5 in that queue and upon disconnecting the currently conducted call, the user will be immediately connected to the caller of call No. 5. In the alternative, the user may indicate his wish to put the current session on hold and to switch from this current call immediately to call number 5.

According to another option, the user may indicate to the WX to re-route one or more of the waiting calls to a voice mail box or to comply with any other pre-defines management rule provided to the WX.

In addition, the method described in this example may further comprise a step where the desktop telephone user may select audio signals and/or video signals that will be transmitted towards the initiator of the request, while the call with the desktop device is being established or being kept on hold. Preferably, the audio signals and/or video signals are selected in response to identifying the type of the device initiating the call.

According to yet another embodiment, a replacing station may be provided which is operative to receive arriving calls instead of the desktop telephone device to which the call was destined. Such replacement may be in response to a request sent by the desktop telephone user to the public cellular network center. Preferably, the replacing station is selected from a routing list stored at the public cellular network center, or the WX.

This embodiment enables the user to change to various pre-defined presence scenarios. The presence scenarios and routing instruction are stored in the cellular network center, and preferably each presence scenario is associated with suitable operative instructions, for example: “in meeting” scenario will be translated by the network so that all arriving calls should be forwarded to the secretary's station. Once the desktop telephone user changes the scenario, a message is sent to wireless centrex, which will handle incoming calls based on the predefined routing rules.

As previously described in one of the embodiments of the present invention, a transfer message may be associated with an arriving request, e.g. sent from the cellular network center to trigger an arriving call being placed on hold.

The transfer can be requested by the desktop telephone user (e.g. when the user is busy with another communication session) and if that device belongs to a private network, executed by a switch associated with that private network. In such a case, notifications will preferably be stored locally. Alternatively, the desktop telephone device sends message to a communication device such as a wireless centrex which takes control over the transfer request, manages the process, while instructions such as re-routing schemes and the like are stored at the network's center and are assigned by the wireless centrex, e.g. to the transfer destination.

The message is sent to the receiving user preferably via USSD or a real time data message via a data communication channel. The data sent in such a message is typically data regarding the call information such as ANI, DNIS (called number by number, but can be by done by name, too, if the system of the invention can match it with its own database), in order to enable the receiving phone to generate the right message.

Optionally, the receiving user may view the message and then select from a list of several options, the preferred way of handling the call (e.g. divert the call to secretary, send to voice mailbox, transfer to someone else such as the boss, etc.)

Another option is to send a voice prompt as the message, which will be played to the receiving party (canned voice message, such as “please set a meeting with caller”, “take care of this” etc.). The receiver may then request to listen again to the message, answer the caller, etc. In this case there is a need for an IVR or Intelligent Peripheral infrastructure to allow playing the messages.

In accordance with another embodiment of the invention, the method further comprises a step of providing a pre-defined auto reply to the calling party in response to a call received at the desktop telephone device. Such pre-defined auto reply can be an e-mail, an SMS, a voice message, and the like. Therefore, the end user may define his line to send such an auto reply to the calling party, providing the latter by using TTS or wav type of file with any details desired such as “I am out of my office”, “will return on ______”, “will have limited access to my voice mailbox”, etc. Preferably, the type of the pre-defined auto reply is selected based on the type of the device originating the incoming call (e.g. wireless and wireline). For wireless party originating the call, the message can be in a form of SMS, while for a wireline the message may be in the form of an e-mail or a voice announcement.

As previously explained, the method provided may further comprise a step of forwarding a call to an answering service associated with the public cellular network and have the message that will be left thereat by the caller. For example, if the request for communication session is made to one or more of the addresses associated with the single desktop telephone device. The message will be forwarded to the desktop device, either automatically, or in response to the desktop telephone device request to pull the messages received.

Thus, the present invention enables a mobile operator to provide a full premise service to a company, with no need for regulation approval.

In addition, other features, such as the following ones may be associated with such a desktop telephone:
View presence of other user (e.g. boss) before transferring the call. The presence of a user may be viewed either physically (e.g. using a small lamp that lights up at the button associated with the user's extension), or via the telephone interface showing the presence of all users in a group.
buttons/soft keys to establish a call or send a message to a predefined extensions and numbers
Buttons/soft keys to establish a conference call, and or transfer a call.
User may define the functionality of a button/soft key
Speaker phone
Screen pop—desktop can communicate with a PC enabling the user to control the call control from the desktop The wireless desktop phone communicates with a PC and enables all call control functionality from the PC. The PC softphone, may communicate directly with the desktop wireless phone via bluetooth or other compatible solution as known in the art per se.
   Let us consider now the following example:

When the desktop telephone rings, data regarding status and caller ID is sent to a soft phone application implemented by a PC. Based on certain pre-defined rules, the soft phone will pop on screen (screen pop) with the relevant call data. The user of the desktop telephone views the data received on the screen of the PC and decides whether to accept, reject, divert etc. the call. In addition, the call control is conducted via the soft phone (including transfer button, etc.)

Furthermore, as this softphone operates in conjunction with a device connected to a wireless network. The user may use a headset connected to PC and then voice signals will also be transported over the bluetooth connection (or any other type of connection implemented).

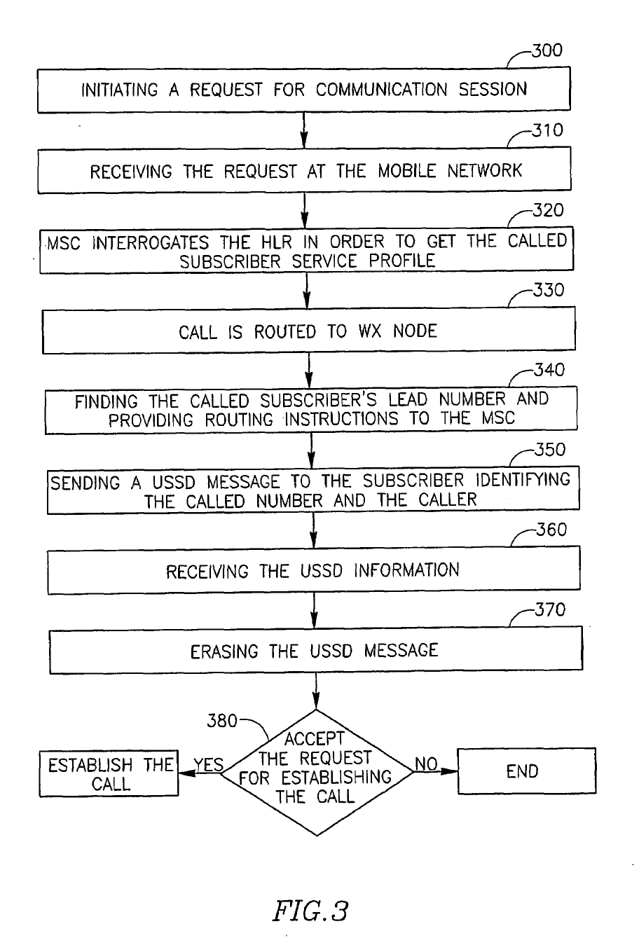

Let us now consider another example illustrated in the flow chart shown in FIG. 3, of implementing a solution provided by the present invention for inbound voice call addressed to a mobile user, wherein the wireless Centrex also operates as an IN signaling node.

By this example, a request is initiated to establish a communication session, e.g. a telephone call, with a certain subscriber of a mobile network that is also a subscriber of the wireless centrex system (step 300). The request may either be initiated by a user belonging to that mobile network, or from any external network (i.e. PSTN). Similarly, the request may be in the form of an e-mail sent to the user's e-mail address, for presenting it on his mobile device.

The request enters the mobile network (step 310) via a Gateway Mobile Switching Center (GMSC), for example: a call from the PSTN with a mobile dialed number will be routed to the GMSC, and received at a MSC/GMSC of the mobile network.

The MSC/GMSC then interrogates the HLR (step 320), in order to get the called subscriber service profile. According to the HLR's Terminate IN Key, the IN signaling of the call is routed toward a wireless centrex node (“WX”) of the present invention. Alternatively, the IN signaling of the call will be routed toward the WX according to the dialed number (e.g. all numbers between “1001” and “1100” should be routed to the WX) (step 330).

The WX receives details about the call initiator (i.e. ANI, called number, if the subscriber is attached to the network or the last VLR update).

The subscriber of this example has several lines associated with his one device (different addresses), all of which are managed by the WX node. The subscriber has one lead (e.g. default) number and a list of additional numbers (addresses) is associated at the WX node with that subscriber. When a call is received on any of the subscriber's lines, the following process is initiated.

At the WX, the number dialed is matched against the pre-defined list, and the appropriate lead number for the subscriber is determined, and based on the information available, e.g. the lead number, routing tables, rules and other information, returns to the MSC with routing instructions for that call (step 340). In some cases, in which the mobile network has limited IN capabilities, or additional resources are needed, the WX may request to route the call to the WX Service Node, which will physically control and route the call.

A USSD message is then sent to the subscriber's lead number at his mobile device preferably with information regarding the called number and ANI of the caller (step 350).

The subscriber receives the information embedded in the USSD message while his telephone is ringing (step 360).

The subscriber presses any key and USSD message is erased (step 370).

The Subscriber views the regular incoming call screen, and can accept or reject the call (step 380)

As an alternative, the subscriber may receive in step 360 the USSD message before the telephone is ringing. Then the subscriber may select an action from a known list. The USSD will transfer the selection to WX node, which will route the call based on subscriber selection and other parameters that are stored at the management of the WX.

The MSC will route the call based on the instructions it received from the WX, while the latter will continue to manage the call and receive updates regarding the call status (e.g. once the call is disconnected the MSC will send the information to the WX via signaling) (step 350). Based on the call information, the WX routing tables and rules and other parameters, the WX will decide if and when to make changes in respect of this call.

It will be appreciated that although various aspects of the invention have been described with respect to specific embodiments, alternatives and modifications will be apparent from the present disclosure, which are within the spirit and scope of the present invention as set forth in the following claims.

1-83. (canceled)

84. A method for establishing communication sessions with a user of a single telephone device, wherein requests to establish said communication sessions are destined to at least two different communication addresses.

85. A method according to claim 84, which comprises the steps of:
establishing a pre-defined list of communication addresses to be associated with said single telephone device;
providing a lead number for said single telephone device; and
for each of the other communication addresses associated with said single telephone device, providing a re-routing scheme to enable handling any request to establish a communication session through any of the addresses comprised in said pre-defined list, through said lead number.

86. A method according to claim 84, further comprising the step of providing said single telephone device with an indication that relates to the address that was requested, before establishing the requested communication session with said single telephone device.

87. A method according to claim 84, further comprising a step of associating a message with the communication session being established for display at said single telephone device.

88. A method according to claim 87, wherein said single telephone device is operative in a cellular network and said message is transmitted to said cellular telephone by using USSD.

89. A method according to claim 85, further comprising a step of diverting a call destined to said single telephone device, to an address which is not included in said pre-defined list of communication addresses.

90. A method according to claim 89, further comprising a step of associating a message with said diverted communication session.

91. A method according to claim 90, wherein said message is generated in response to a pre-define code sent by said single telephone device.

92. A method according to claim 84, wherein one or more requests to establish one or more communication sessions are received while another communication session is being held with said user.

93. A method according to claim 92, further comprising the step of providing said user with indications, denoting the one or more requests received for establishing said one or more communication sessions.

94. A method according to claim 93, wherein said method further comprising a step of determining which of said one or more requests shall be accepted.

95. A method according to claim 94, wherein all of the one or more requests identified for acceptance, are retained in a buffer and wherein said method further comprising the step of changing the order of requests queued in said buffer in response to one or more instructions generated by said user.

96. A method according to claim 88, wherein said message comprises details associated with an arriving request for establishing the communication session.

97. An apparatus adapted for use in a cellular network and comprising buffering means adapted to buffer requests to establish a plurality of communication sessions with a single cellular telephone device having a single subscriber address identification defined in said cellular network, wherein said plurality of requests are buffered while said single cellular telephone device is engaged with another communication session.

98. An apparatus adapted for use in a cellular network and adapted to receive requests to establish a plurality of communication sessions that specify at least two different communication addresses, and route said requests to a single cellular telephone device having a single subscriber address identification defined in a cellular network.

99. An apparatus according to claim 98, further comprising:
buffering means adapted to buffer a plurality of requests to establish a plurality of communication sessions with said single cellular telephone device, wherein said plurality of requests are buffered while said single cellular telephone device is engaged with another communication session; and
means operative to forward indications denoting the buffered requests for establishing said communication sessions, towards said single cellular telephone device.

100. An apparatus according to claim 99, further comprising means operative to receive instructions that have been forwarded through said single cellular telephone device and adapted to re-arrange the order by which said requests to establish a plurality of communication sessions are queued in said buffering means in response to the instructions received.

101. An apparatus according to claim 98, which comprises:
means for establishing a pre-defined list of communication addresses to be associated with a single said single cellular telephone device;
means for associating a lead number with said single cellular telephone device; and
means for carrying out a routing scheme to enable handling a request to establish a communication session through any of the addresses comprised in said pre-defined list, through said lead number.

102. An apparatus according to claim 98, further comprising means operative to associate a message with a request for establishing a communication session for display at said cellular telephone device.

103. An apparatus according to claim 102, wherein said message is transmitted to said cellular telephone device by using USSD type of transmission.

104. An apparatus according to claim 98, further comprising means for diverting a communication session that was originally destined to said single cellular telephone device, to an address which is not included in said pre-defined list of communication addresses.
